(19) United States
(12) Patent Application Publication
(10) Pub. No.: US 2018/0239824 A1
(43) Pub. Date: Aug. 23, 2018

(54) TARGETED FEEDBACK SYSTEMS AND METHODS

(71) Applicant: Microsoft Technology Licensing, LLC, Redmond, WA (US)

(72) Inventors: Melroy D'SOUZA, Bellevue, WA (US); Aaron CON, Bellevue, WA (US); Rajesh KULKARNI, Sammamish, WA (US); Arun SACHETI, Sammamish, WA (US)

(73) Assignee: Microsoft Technology Licensing, LLC, Redmond, WA (US)

(21) Appl. No.: 15/600,056

(22) Filed: May 19, 2017

Related U.S. Application Data
(60) Provisional application No. 62/461,134, filed on Feb. 20, 2017.

(51) Int. Cl. G06F 17/30; G06F 11/30

(52) U.S. Cl. CPC G06F 17/30864; G06F 11/2294; G06F 17/301; G06F 11/302

(57) ABSTRACT

Feedback systems and methods for an application are provided. More specifically, the feedback systems and methods provide quantitative and qualitative user feedback from a target group of users utilizing the application in the market. As such, the feedback systems and methods provide feedback questions to an identified user within the target group based on usage data, type data, usage context, and/or the target group of the identified user of the application. Additionally, the feedback systems and methods may limit access to new application components to a target group of application users. Accordingly, the feedback systems and methods are more comprehensive when compared to previously utilized feedback system for market use because they provide contextual quantitative and qualitative targeted user feedback from a target group of application users.

### BACKGROUND

Service applications perform one or more services for other computing systems and/or users. Service applications run on a client or server computing device, such as a laptop or a smart phone, or are accessed by a client computing device running over one or more servers. An online service application is an application that provides a service to the user that is remote from the user or the user's client computer and has to be accessed via a network, such as the internet. Search engines, web browsers, gaming application, and fitness tracking application, are examples of different service applications. While tracking user behavior with respect to various features of such service applications is available, this information fails to provide insight into user attitudes and opinions regarding these features.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to feedback systems and methods for an application. More specifically, the feedback systems and methods disclosed herein provide quantitative and qualitative user feedback from a target group of users utilizing the application in the market. As such, the feedback systems and methods as disclosed herein generate and provide feedback questions based on usage data, type data, usage context, and/or the target group of the identified user of the application. Additionally, the feedback systems and methods as disclosed herein may limit access to new application versions, features and/or services to a target group of application users. Accordingly, the feedback systems and methods disclosed herein for an application are more efficient and gather better quantitative and qualitative targeted user feedback when compared to previously utilized feedback system.

One aspect of the disclosure is directed to a targeted feedback system for an online service application. The system includes at least one processor and a memory. The memory encodes computer executable instruction that, when executed by the at least one processor, are operative to:
identify a user accessing the application;
collect at least one of type data and usage data associated with the user;
compare at least one of the type data and the usage data to a group threshold;
determine that at least one of the type data and the usage data meets the group threshold;
identify that the user is a member of a target group based on the determining that at least one of the type data and the usage data meets the group threshold;
providing a new component of the application to the user in response to identifying the user;
collect user engagement with respect to the new component;
analyze the user engagement to determine a usage context of the user during use of the new component;
generate a feedback question regarding the new component based on the usage context; and
provide the feedback question to the user.

In another aspect, a targeted feedback method for an online service application is disclosed. The method includes:
collecting data associated with a user of the application;
comparing the data to a group threshold;
determining that the data meets the group threshold;
collecting user engagement of the application in response to determining that the data meets the group threshold;
analyzing the user engagement to determine a usage context for the application;
generating a feedback question for the application based on at least one of the usage context and the data; and
providing the feedback question to the user

In yet another aspect of the invention, the disclosure is directed to a targeted feedback system. The system is a computing device that includes a processing unit and a memory. The processing unit implements an application and a feedback system. The computing device is operable to:
identify a user of the application;
compare at least one of type data and usage data associated with the user to a group threshold;
determine if at least one of the type data and the usage data meets the group threshold;
in response to a determination that at least one of the type data and the usage data meets the group threshold:
   collect user engagement of at least one identified component of the application;
   determine a usage context for the identified component based on the user engagement;
   generate a feedback question for the identified component based on the usage context; and
   provide the feedback question to the user.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1A is a schematic diagram illustrating a feedback system for an application being utilized by a user via a client computing device, in accordance with aspects of the disclosure.

FIG. 1B is a schematic diagram illustrating a feedback system for an application being utilized by a user via a client computing device, in accordance with aspects of the disclosure.

FIG. 1C is a schematic diagram illustrating a feedback system for an application being utilized by a user via a client computing device, in accordance with aspects of the disclosure.

FIG. 1D is a schematic diagram illustrating a feedback system for an application being utilized by a user via a client computing device, in accordance with aspects of the disclosure.

FIG. 2 is a schematic flow diagram illustrating how the feedback system is utilized to collect targeted user feedback from different target groups of users to improve different features of an application, in accordance with aspects of the disclosure.

FIG. 3 is schematic diagram illustrating a browser interface for a search engine in a mapping service utilizing the feedback system, in accordance with aspects of the disclosure.

FIG. 4 is block flow diagram illustrating a feedback method for an application, in accordance with aspects of the disclosure.

FIG. 5 is a block diagram illustrating example physical components of a computing device with which various aspects of the disclosure may be practiced.

FIG. 6A is a simplified block diagram of a mobile computing device with which various aspects of the disclosure may be practiced.

FIG. 6B is a simplified block diagram of the mobile computing device shown in FIG. 6A with which various aspects of the disclosure may be practiced.

FIG. 7 is a simplified block diagram of a distributed computing system in which various aspects of the disclosure may be practiced.

FIG. 8 illustrates a tablet computing device with which various aspects of the disclosure may be practiced

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

Service applications are becoming more and more prevalent and are being utilized for more and more tasks. As understood by those skilled in the art, on-line service applications are software applications that perform services for other computer systems and/or users, are generally remote from the client computing device of the user, and are utilized or accessed via a network, such as the Internet. Administrators of the service applications are always looking for ways to improve the service applications to increase user enrollment and/or engagement. Additionally, administrators of the service applications are always looking for ways to improve or gauge user response to new versions, services, and/or features provided by the service application to increase user enrollment and user engagement. Some service applications offer more than one service, such as a search engine service and a mapping service. Each of these services may provide different features or options, such as offering driving directions or walking directions in the mapping service of the application. The term “component” as utilized herein refers to a version, a service, and/or a feature of an application.

Previously, if feedback was desired from market use of an application and/or components of an application, a feedback technique referred to as A/B testing or flighting was utilized. This previous technique released one or more new components of the application to a random selection of users (a test group) and the normal application to the rest or another random selection of users (a control group). Next, this previous feedback technique monitored and/or collected user engagement (quantitative feedback) for the application from the test group and the control group. The flighting technique does not collect qualitative feedback, such as the “why” behind the user engagement numbers. Further, the flighting feedback technique is not able to control or limit which users have access to certain components of the application, nor is it able to selectively choose which users the quantitative feedback is gathered from. Additionally, the flighting technique cannot accurately measure user reaction to dramatic application changes that take time for user adjustment. Additionally, the flighting technique may average out user engagement across the users exposed to the flight, diluting, which can skew the statistical data between early and late adopters for flights that last less than seven days,

The systems and methods as disclosed herein are directed to a targeted feedback systems and methods for an application. The application may be a service application or an on-line service application. The targeted feedback systems and methods as disclosed herein provide a feedback technique that is able to collect quantitative and qualitative user feedback from a targeted group of individuals. Further, the feedback systems and methods as disclosed are capable of generating and providing feedback questions that are based on type data, usage data, usage context, and/or target group. Additionally, the feedback systems and methods as disclosed herein are able to target particular users for feedback and/or are able to limit which users have access to a given application or new component of the given application. The ability of the feedback systems and methods described herein to collect quantitative and qualitative user feedback from targeted individuals and/or to generate or provide targeted feedback questions provides for a better, more efficient, more controlled, and more easily used feedback system for market testing than prior systems that did not collect qualitative feedback, target a particular user population and/or generate contextually relevant feedback questions.

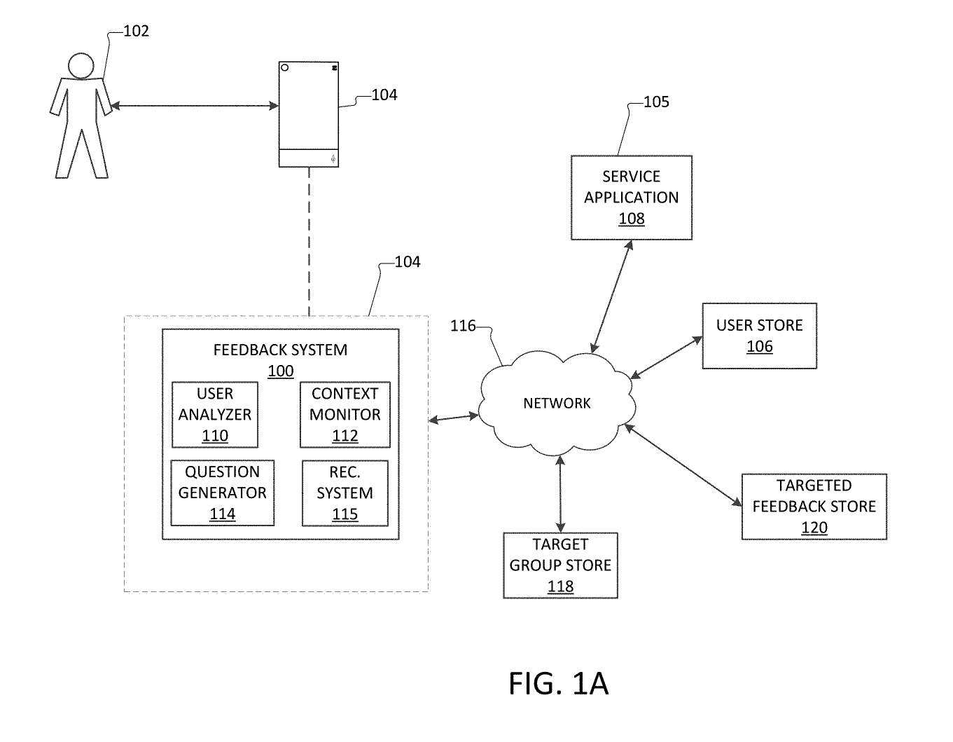

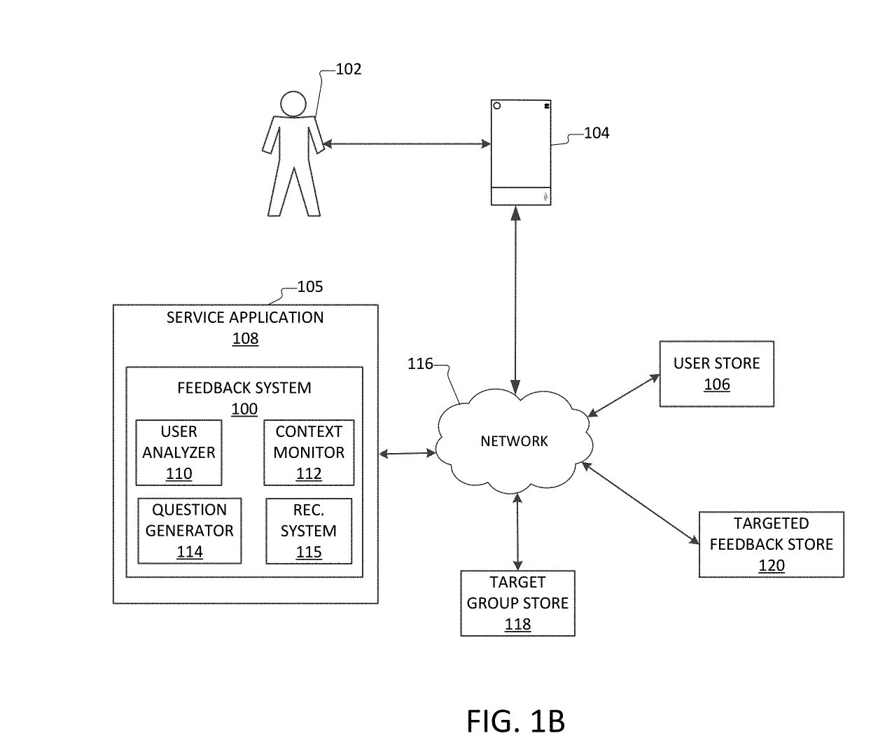

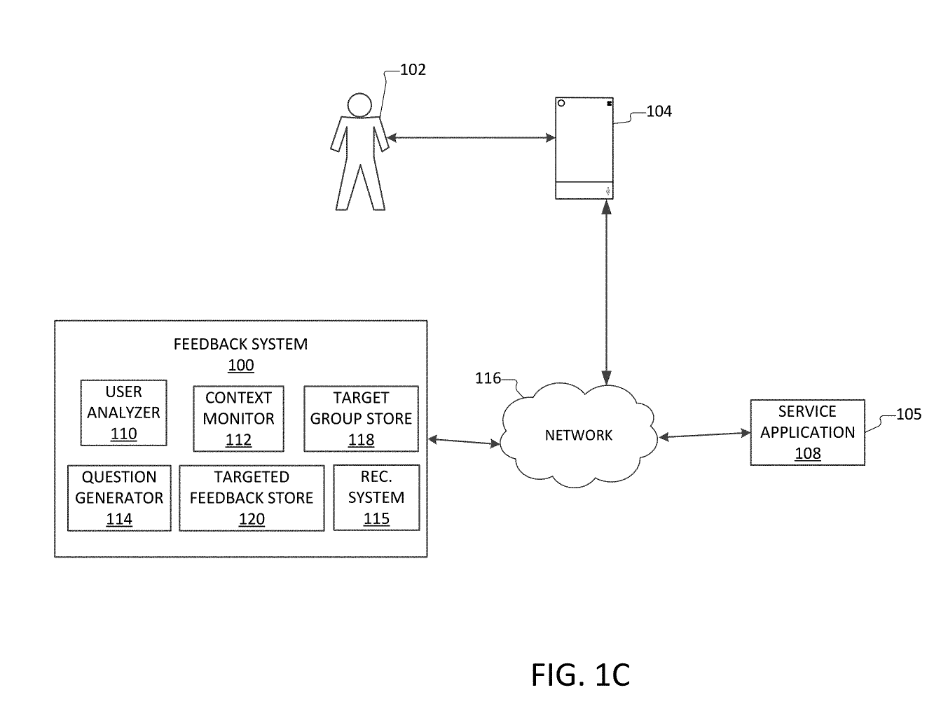

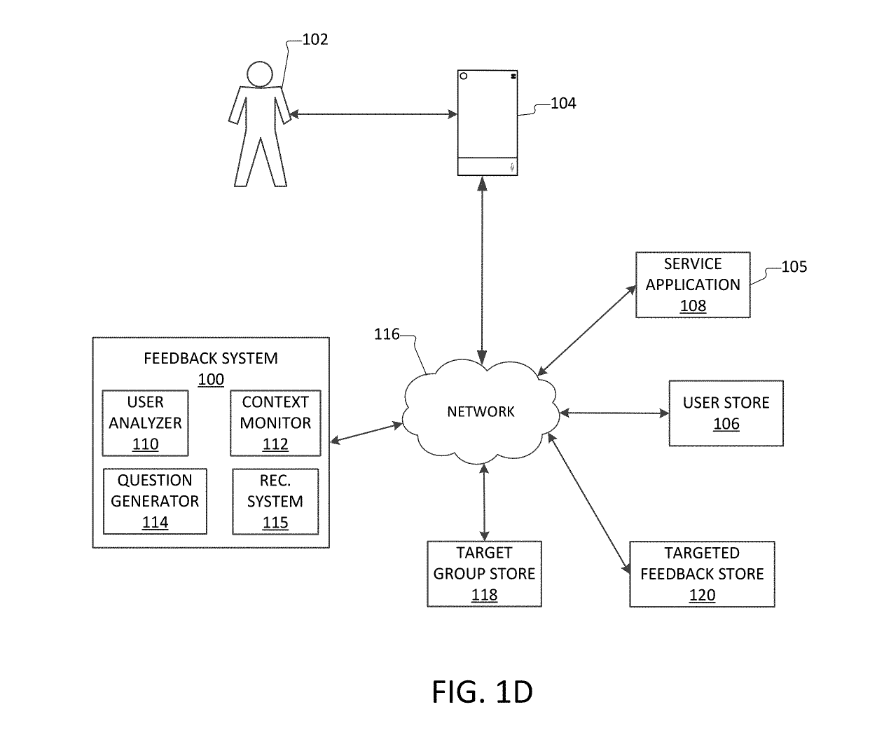

FIGS. 1A-1D illustrate different examples of a feedback system 100 for an application 108, such as a service application, being utilized by a user 102 via a client computing device 104, in accordance with aspects of the disclosure. In some aspects, the service application 108 is an online service application, such as search engine or a social media application. The feedback system 100 is utilized by the application 108 to collect qualitative and quantitative user feedback about the application or one or more components of the application. Further, the feedback system 100 may be utilized by the application 108 to control access to an application or one or more components of the application to specific users and/or to limit feedback collection to a target group of users. In some aspects, the feedback system 100 is part of the application 108, as illustrated in FIG. 1B. In other aspects, the feedback system 100 is separate and distinct from the application 108, as illustrated in FIGS. 1A, 1C and 1D. Accordingly, communication between the application 108 and the feedback system 100 is enabled.

The feedback system 100 may include a user analyzer 110, a context monitor 112, a question generator 114 and/or a recommendation system 115, as illustrated in FIGS. 1A-1D. In some aspects, the feedback system 100 also includes a targeted feedback store 120 and/or target group store 118, as illustrated in FIG. 1C. In other aspects, the feedback system 100 communicates via a network 116 with a targeted feedback store 120 and/or target group store 118 that are separate and distinct form the feedback system 100, as illustrated in FIGS. 1A, 1B, and 1D. Accordingly, a user analyzer 110, a context monitor 112, a question generator 114, a recommendation system 115, a targeted feedback store 120, and/or a target group store 118 may communicate between each other. In further aspects, the feedback system 100 communicates with and/or accesses a user store 106 via a network 116. In some aspects, the targeted feedback store 120, target group store 118, and/or the user store 106 are one or more databases.

In some aspects, the feedback system 100 is implemented on the client computing device 104, as illustrated by FIG. 1A. In a basic configuration, the client computing device 104 is a computer having both input elements and output elements. The client computing device 104 may be any suitable computing device for implementing the feedback system 100. For example, the client computing device 104 may be a mobile telephone, a smart phone, a tablet, a phablet, a smart watch, a wearable computer, a personal computer, a gaming system, a desktop computer, a laptop computer, and/or etc. This list is exemplary only and should not be considered as limiting. Any suitable client computing device 104 for implementing the feedback system 100 or for collecting targeted quantitative and qualitative user feedback may be utilized.

In other aspects, the feedback system 100 is implemented on a server computing device 105, as illustrated in FIGS. 1B-1D. The server computing device 105 may provide data to and/or receive data from the client computing device 104 through a network 116. In some aspects, the network 116 is a distributed computing network, such as the Internet. In further aspects, the feedback system 100 is implemented on more than one server computing device 105, such as a plurality or network of server computing devices 105. For example, the user analyzer 110 may be located on the same server computing device 105 as the context monitor 112, as illustrated in FIGS. 1A-1D, or may be located on separate server computing devices 105. In some aspects, the feedback system 100 is a hybrid system with portions of the feedback system 100 on the client computing device 104 and with portions of the feedback system 100 on one or more server computing devices 105.

In some aspects, the service application 108 is an online service application 108. As such, in some aspects, millions of different users from across the globe may have access to service application 108. In other words, any user with access to the World Wide Web may have access or utilized the service application 108. The user analyzer 110 of the feedback system 100 identifies a user 102 accessing or utilizing the service application 108. The user may be identified utilizing a user store 106. The user store 106 may be an index of information that can be utilized to identify different users. In some aspects, a user is specific client computing device 104. In other aspects, a user 102 may be associated with a plurality of different client computing devices 104. In these aspects, the identification of the client computing device 104 may identify the user 102. In some aspects, the user 102 logs in to utilize the service application 108. In these aspects, the service application 108 (also referred to herein as “the application”) may have identified the user based on the login information and may track and store type and usage data about the identified user based on the user login information or profile information associated with the user login. In these aspects, the user analyzer 110 collects the user identification and/or usage and type data for the identified user from the service application 108. In other aspects, the user may be identified based on the location of the user, user profile, personal settings, and/or search history of the user.

Next, the user analyzer 110 may collect usage and/or type data for the identified user. The term “collect” as utilized herein refers to the active retrieval of data and/or to the passive receipt or receiving of data. In some aspects, the user analyzer 110 collects usage and/or type data from the user store 106. For example, any known categories and/or demographics to which the identified user is a member may be provided in the type data. The usage data provides the historical engagement rate of the user for the application and/or one or more components of the application. The usage data may also include usage time and/or the times of the day the user utilizes the application or one or more components of the application. The usage data may also include any historical information relating user interaction or behavior with respect to the application.

Once the usage and/or type data has been collected, the user analyzer 110 compares the usage and/or type data to a group threshold. The group threshold is a preconfigured threshold that identifies a target group of users. In some aspects, the user analyzer 110 collects the group threshold from the target group store 118. In these aspects, the user analyzer 110 may change the group threshold in response to an update on the target group store 118. As such, the feedback system 100 may analyze feedback from a different target group of users in response to an update to the target group store 118.

The group threshold may include a predetermined usage amount and/or a specific demographic or category. For example, the group threshold may require that the user utilize the application at least once a week and be located in the United States. In another example, the group threshold may require that the user utilize a specific service of the application at least once a day and be female. In a further example, the group threshold may require that the user utilize a specific feature of the application at least twice a day. In another example, the group threshold may require that the user has only utilized the application five times or less.

The user analyzer 110 determines if the usage and/or type data for the identified user meets the group threshold based on the comparison. If user analyzer 110 determines that the usage and/or type data meets the group threshold, the user analyzer 110 determines that the identified user is a member of the target group. If the user analyzer 110 determines that the usage and/or type data does not meet the group threshold, the user analyzer 110 determines that the identified user is not a member of the target group.

The context monitor 112 collects the result of the comparison from the user analyzer. In response to not meeting the group threshold or to determining that the user is not part of the target group by the user analyzer 110, the context monitor 112 of the feedback system 100 will not provide any new applications, features and/or services to the identified user, will not monitor user engagement of the application, will not generate or provide feedback questions, and/or will not collect any feedback from the user. In other words, the feedback system 100 will discontinue communications and/or monitoring of the user in response to determining that the user is not part of the target group.

In some aspects, in response to the user analyzer 110 determining that the user meets the group threshold and/or otherwise determining that the user is part of the target group, the context monitor 112 of the feedback system 100 may offer the user access to one or more new components of the application. In alternative aspects, the context monitor 112 of the feedback system 100 may offer users that are members of the target group access to one or more new components of the application at random, so that some members of the target group do not receive the one or more new components of the application to create a control group for the feedback system. In further aspects, the one or more new components of the application may be accessed from the target group store 118. As such, context monitor 112 may change the one or more new components of the application offered to the target group of users based on an update the target group store 118.

In response to determining that the user is part of the target group, the context monitor 112 of the feedback system 100 may collect data corresponding to user engagement of the application and/or one or more components of the application, such as a provided new component. The context monitor 112 analyzes the user engagement with the application and/or one or more components of the application to determine a usage context during use of the application and/or the one or more components of the application. The usage context identifies what aspects of the application the user is currently accessing and how much time the user spent utilizing the application and/or one or more components of the application during this current interaction with the application and/or one or more components of the application. In some aspects, the usage context is a log or history of the identified user's current or most recent experience with the application and/or is updated in real time or substantially real time based on the identified user's ongoing experience with the application and/or one or more components of the application. In some aspects, the identified user is already using a new application version, a new feature of the application, and/or a new service of the application. In other aspects, the identified user does not utilize the new application version, the new feature of the application and/or the new service of the application until one or more new components are offered to the user by the context monitor 112 of the feedback system 100.

The question generator 114 collects the usage context of the identified user from the context monitor 112. In some aspects, the question generator 114 collects the usage and/or type data from the user analyzer 110. In some aspects, the question generator 114 generates a feedback question based on the usage context. In other aspects, the question generator 114 generates a feedback question based on the usage context, the target group, the type data, and/or the usage data of the identified user. As such, the feedback question is specifically targeted and contextually relevant to the identified user and the identified user's experience with the application.

For example, if the usage data of the identified user indicates that this user typically utilizes a certain feature, but usage context suggests that the identified user did not utilized this feature on a particular occasion, the question generator 114 of the feedback system 100 may generate a feedback question to ask the identified user why he or she did not utilize this feature. In another example, if the identified user is part of a target group that utilizes the application on average for at least an hour during each interaction and the usage context indicates that the identified user only utilized a new version of the application for 20 minutes, the question generator may generate a feedback question to ask the identified user why he or she did not utilized the application for a longer period of time. As such, the question generator may notice inconsistencies or differences with respect to collected usage data, context data, type data, etc., and may ask a feedback question based on these inconsistencies. Alternatively, if the usage context is high for a given feature, application, or service, the feedback system may ask why the user was so engaged in the feature, application, or service. In further aspects, the feedback questions may be directed to specific usage, features, and/or services of the application which have been adapted or modified based on the collected user information, such as the target group, the usage data, the type data, and/or the usage context.

In some aspects, the question generator 114 will search a targeted feedback store or index 120 for feedback questions. The targeted feedback store 120 may contain feedback questions that are annotated or labeled for specific usage contexts for the target group or a specific type of user. As such, the question generator 114 may search and pull an appropriate feedback question for the target group and/or identified user based on the usage context, type data and/or user engagement (as evidenced by usage data) of the identified user. In alternative embodiments, the question generator 114 may create or generate new questions from scratch utilizing rating, ranking, open-ended survey, statistical, heuristic and/or learning-model techniques. For example, the questions generator 114 may use question A from the feedback store 120 if the user does X (based on usage context), and ask question B from the feedback store 120 if the user does anything else besides X (based on usage context).

In further aspects, the question generator 114 may also utilize preconfigured contextually relevant questions for the target group of users. In these embodiments, the preconfigured contextually relevant questions for the target group of users are provided to the user in response to determining that the user is part of the target group or in response to determining that the user's collected data meets the group threshold. Responses to the preconfigured contextually relevant questions from members of the target group of users may be collected and/or analyzed by the recommendation system 115 similarly to how the replies to the generated feedback questions are collected and analyzed.

The question generator 114 of the feedback system 100 provides the targeted feedback question to the user. In some aspects, the targeted feedback question is provided by a client computing device 104 to the user. In other aspects, instructions are sent to the client computing device 104 to provide the targeted feedback question to the user by the question generator 114. The client computing device provides the feedback question to the user utilizing any known visual, audio, tactile, holographic, and/or other sensory mechanisms. For example, the client computing device 104 may provide the feedback question through a visual display on a display screen on the client computing device and/or audibly through a speaker.

In other aspects, the question generator 114 may provide the identified user with the identified user with an option to provide feedback at any given time or at specified time based on usage context of the application and/or one or more components of the application. In these aspects, the user proactively decides to input and provide feedback as desired to the feedback system 100. The spontaneously provided feedback from the user is collected and/or analyzed similar to a reply of a provided feedback question by the recommendation system 115.

In other aspects, the feedback system 100 allows an administrator of the application to generate and/or provide administrator generated feedback questions based on the usage context, usage data, and/or type data. In further aspects, the administrator of the application may be able to provide the administrator generated feedback questions to the user in a live chat with the user and/or even to have a dialog with user based on the usage context.

The recommendation system 115 of the feedback system 100 collects the response or reply from the user to the feedback question and/or the corresponding feedback question from the question generator. In some aspects, the recommendation system 115 collects other responses or replies to other feedback questions from other members of the target group, along with the other corresponding feedback questions. In further aspects, the recommendation system 115 may collect data regarding user engagement and/or usage context for the other members of the target group. The recommendation system 115 may store the identified user's replies and corresponding feedback questions, the other members' replies and other corresponding feedback questions, the identified user's usage context and/or user engagement, and the other members' user engagements and/or usage contexts.

In some aspects, the recommendation system 115 analyzes the collected information, including one or more of the identified user's reply and corresponding feedback question, the other members' replies and other corresponding feedback questions, the identified user's usage context and/or user engagement, and the other members' user engagements and/or usage contexts. The recommendation system 115 may then determine a recommendation for modifying the application based on the analysis of such collected information. In further aspects, the application is modified based on the recommendation from the recommendation system.

The recommendation system 115 may provide or provide access to the collected information and/or the recommendation to the administrator of the application. For example, a report containing the collected information and/or the recommendation may be sent to the administrator. In an alternative example, the report containing the collected information and/or the recommendation is stored on the feedback system 100, but is accessible by the administrator. For example, the administrator may gain access to a report or other feedback data by logging into the feedback system 100. In some aspects, the report containing the collected information and/or the recommendation is provided by a client computing device 104 to the administrator. In other aspects, instructions are sent to the client computing device 104 to provide the report containing the collected information and/or the recommendation to the administrator of the application by the recommendation system 115. The client computing device provides the report containing the collected information and/or the recommendation to the administrator of the application utilizing any known visual, audio, tactile, holographic, and/or other sensory mechanisms. For example, the client computing device 104 may provide the feedback question through a visual display on a display screen on the client computing device and/or audibly through a speaker.

In some aspects, the feedback system 100 may be able to collect targeted user feedback form target groups of users for several different components of the same application or for different applications at the same time. In these aspects, the user analyzer 110 may compare the type and/or usage data for the identified user to a plurality of different group thresholds. In some aspects, the user analyzer 110 collects the plurality of different group thresholds from the target group store 118. The one or more feedback questions generated and provided to the identified user may be based on each target group to which the identified user is a member based on the comparison of the type and/or usage data for the identified user to the plurality of different group thresholds. Accordingly, in some aspects, one user may be a member of a plurality of different target groups. In other aspects, an identified user may be a member of only one target group.

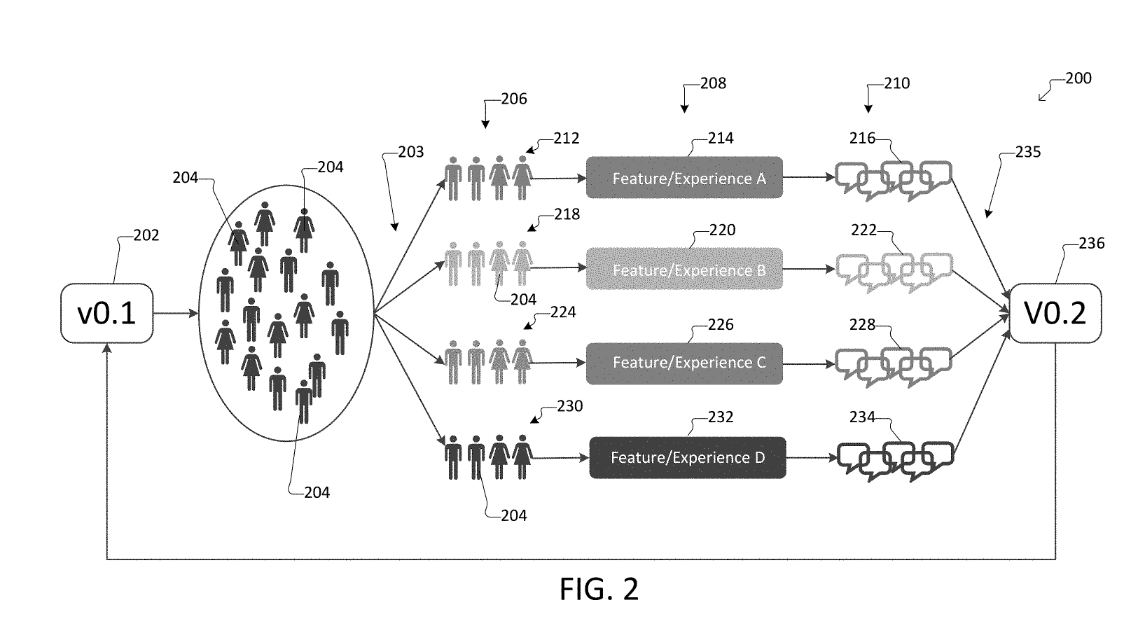

FIG. 2 illustrates a schematic flow diagram 200 of how the feedback system 100 is utilized to collect targeted user feedback from several different target groups of users to improve several different features of an application. For example, the feedback system 100 identifies users 204 of a first version of an application 202. There may be hundreds, thousands, or even millions of users of the first version of the application 202. The feedback system 100 compares the type and/or usage data for each identified user 204 to one or more group thresholds. The feedback system 100 determines if each user 204 should be placed or categorized into one or more target groups 206 or not utilized at all for feedback based on this comparison at flow 203. In this example, targeted qualitative and quantitative feedback 210 is collected from each user in each target group 206 for a different feature 208 of the same application. For example, users 204 in the first target group 212 are utilized to gather targeted feedback 216 on a first feature 214, the users 204 in the second target group 218 are utilized to gather targeted feedback 222 on a second feature 220, the users 204 in the third target group 224 are utilized to gather targeted feedback 228 on a third feature 226, and the users 204 in the fourth target group 230 are utilized to gather targeted feedback 234 on a fourth feature 232. However, because the feedback system 100 generates feedback questions for each user based at least on the usage context of the user in this example, the qualitative feedback gathered for each user of the target group may vary.

The feedback 210 for different features 208 may be analyzed at flow 235 by the feedback system 100 to determine one or more modifications or recommended modifications of the first version of the application 202 to improve the first version of the application 202 based on the collected feedback 210. These modifications and/or recommended modifications may be utilized to create a second version of the application 236 as illustrated in FIG. 2.

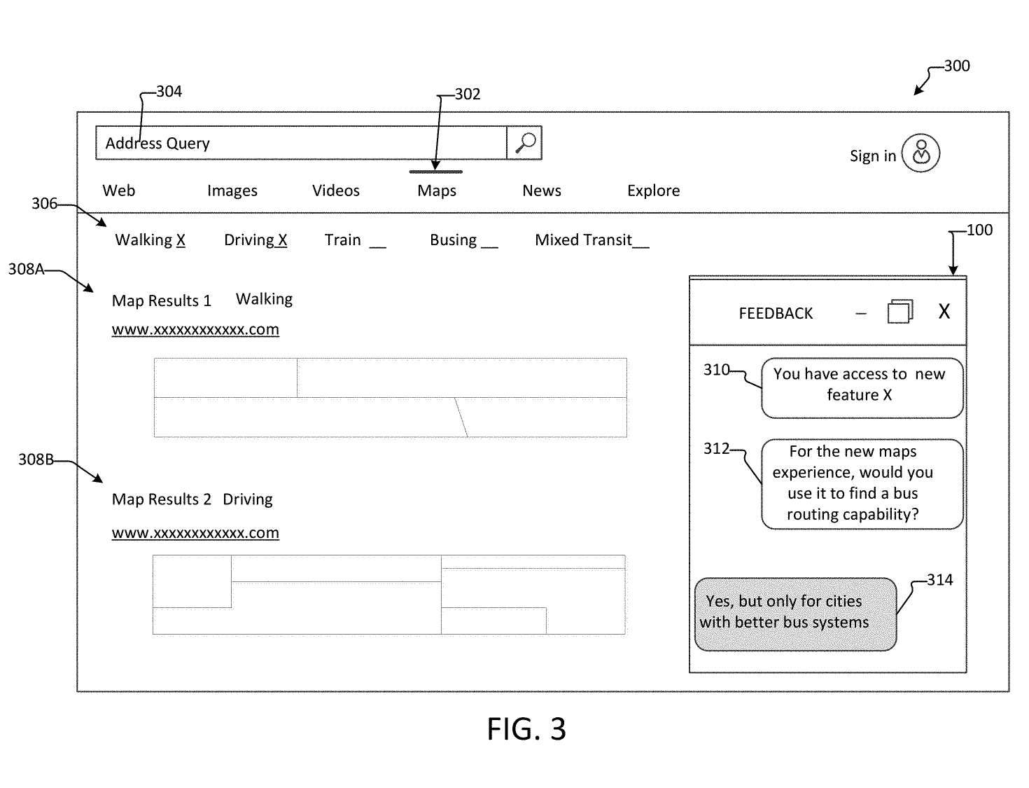

FIG. 3 shows an example of a browser interface 300 for a search engine 108 in a mapping service 302 utilizing the feedback system 100. In this example, the user 102 is utilizing a new mapping service. As illustrated in FIG. 3, the user has input an address query 304 and requested two different map or direction types 306: 1) walking and 2) driving. In response to the address query, the new mapping application lists or provides two different results 308A and 308B, e.g., a walking map and a driving map, to the user.

In the example of FIG. 3, the feedback system 100 identified the user 102 and determined that the user's usage data and/or type data met the group threshold. In this example, the user's usage data met a once a week use of the mapping service for this application. In response to meeting the group threshold, the feedback system 100 provided the user with access to a new mapping service and informed the user of the new service in a prompt 310. Also, in response to meeting the group threshold, the feedback system 100 monitored the user engagement (e.g., usage data) with new mapping service to determine a usage context. For example, it was determined that the usage context included utilizing the walking and driving features, but not utilizing the train, bussing, or mixed transit features. As such, the feedback system 100 in this example generated a feedback question based on the usage context to determine why some of these other features were not utilized. For example, the feedback system 100 asked the user in prompt 312, “For the new maps experience, would you use it to find a bus routing capability?” The feedback system 100 collected the user response 314 that recites, “Yes, but only for cities with better bus systems.” In this regard, the feedback system 100 may analyze this response and determine that the busing feature was not selected due to user location and not due to a deficiency of the application. As such, the feedback system 100 may determine that no recommendations are needed for the new mapping service based on the analysis of the user feedback.

As such, the feedback system 100 allows an application to not only collect quantitative feedback (user engagement and usage context) from a specific target group of users but also collects qualitative feedback (why are the user engagement and usage contexts what they are) by generating and providing feedback questions that are specifically tailored and relevant to each user and his or her user experience with the application. Further, the feedback system 100 collects this data “at scale” or based on market use of the application.

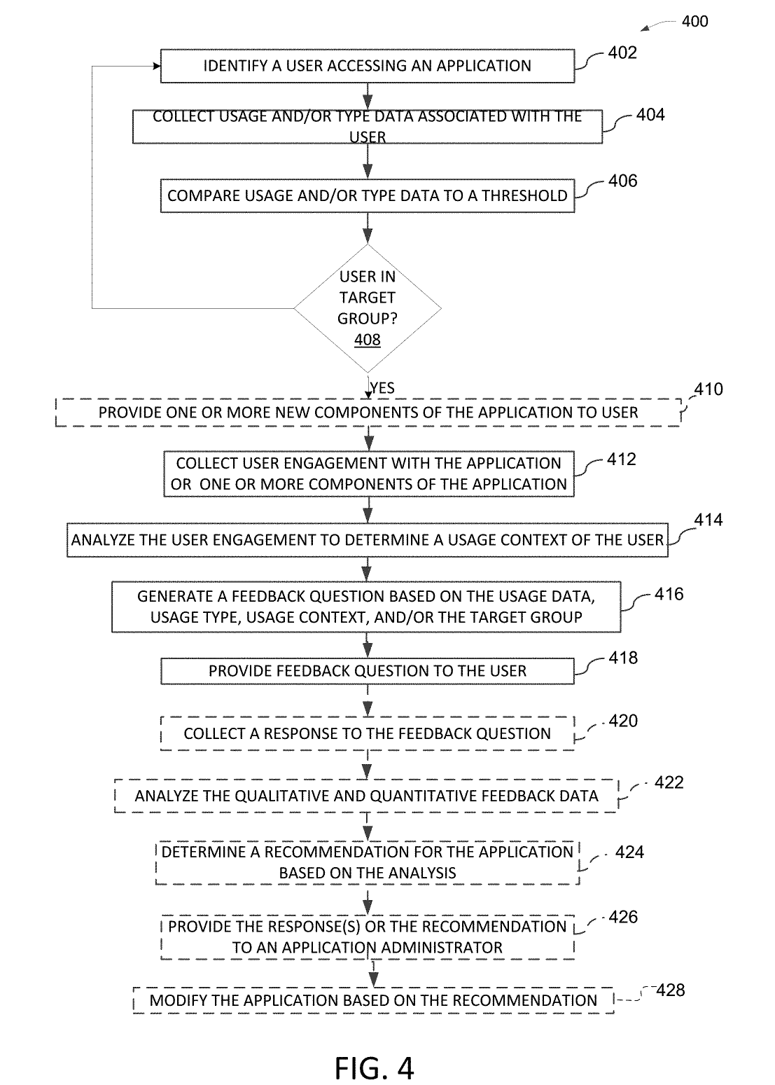

FIG. 4 illustrates a flow diagram conceptually illustrating an example of a targeted feedback method 400 for an application. The application may be a service application and/or an online service application, such as a travel application. In some aspects, feedback method 400 is performed by the feedback system 100. Feedback method 400 is a method for collecting qualitative and quantitative feedback from a group of targeted users in the market place of an application. More specifically, feedback method 400 generates and provides feedback questions to an identified user based on the user's usage data, type data, usage context, and/or target group. In further aspects, feedback method 400 is capable of selectively providing access to new application versions, new services, and/or new features of an application to a particular target group of users who are utilizing the application via a network in the market place.

Feedback method 400 starts at operation 402. At operation 402, a user of an application is identified. In some aspects, the user is identified upon utilizing or accessing the application. In other aspects, the user is identified based on past use of the application. The application may be a service application, such as an online service application. The user may be identified utilizing login information, a client computing device, and/or any other known systems or method for identifying a user.

At operation 404, usage data and/or type data is collected for the identified user. Usage data indicates an engagement rate or any other type of usage data of the application by the identified user. The type data includes any demographic or category to which the user is a known member, such age, education, location, income level, affinities, race, physical activity level, etc.

Feedback method 400 also includes operation 406. At operation 406 the type and/or usage data for the identified user is compared a group threshold. Next, at operation 408, feedback method 400 determines if a user is a member of a target group of users based on a result of the comparison. If the usage data and/or the type data of the identified user meet a group threshold based on the comparison at operation 406, feedback method 400 determines that the identified user is a member of the target group of users at operation 408 and selects to perform operation 410 and/or 412. If the usage data and/or the type data of the identified user does not meet a group threshold based on the comparison at operation 406, feedback method 400 determines that the identified user is not a member of the target group of users at operation 408 and selects to start feedback method 400 over and performs operation 402 for the next user of the application.

In some aspects, feedback method 400 includes operation 410. In some aspects, at operation 410, one or more new components of the application are provided to the identified user in response to determining that the user is a member of the target user group and/or in response to determining that the usage data and/or type data of the user meets the group threshold at operation 408. In other aspects, at operation 410 one or more new components of the application are provided to identified users at random in response to determining that the user is a member of the target user group and/or in response to determining that the usage data and/or type data of the user meets the group threshold at operation 408 to create a control of targeted users for feedback monitoring that do not receive the one or more new components. The one or more new components of the application may be provided to the identified user by sending the one or more new components of the application to the user and allowing access to the one or more new components of the application upon selection. In other aspects, the one or more new components of the application may be provided to the identified user by automatically updating the application being utilized by the user.

In other aspects, the one or more new components of the application are provided to any user of the application. In further aspects, the feedback method 400 is collecting feedback on a current component of the application. In these aspects, operation 412 is performed in response to determining that the user is a member of the target user group and/or in response to determining that the usage data and/or type data of the user meets the group threshold at operation 408. At operation 412, user engagement with the one or more new components of the application may be monitored and usage data may be collected. In further aspects, operation 412 is performed after the performance of operation 410.

At operation 414, the user engagement of the application and/or one or more components of the application are analyzed. Based on this analysis at operation 414, a usage context of the user is determined.

One or more feedback questions are generated based on the usage data, type data, usage context, and/or target group of the identified user at operation 416. As discussed above, the usage data provides the historical engagement rate of the user for the application and/or one or more components of the application. The usage data may also include usage time and/or the times of the day the user historically utilizes the application or one or more components of the application. The usage data may also include any historical information relating user interaction or behavior with respect to the application. In contrast, as also discussed above, the usage context identifies what aspects of the application the user is currently accessing and how much time the user spent utilizing the application and/or one or more components of the application during this current interaction with the application and/or one or more components of the application. In some aspects, the usage context is a log or history of the identified user's current or most recent experience with the application and/or is updated in real time or substantially real time based on the identified user's ongoing experience with the application and/or one or more components of the application.

At operation 418, the one or more feedback questions generated by operation 416 are provided to the identified user. In some aspects, the one or more targeted feedback questions are provided by a client computing device to the user at operation 418. In other aspects, instructions are sent to the client computing device to provide the one or more targeted feedbacks question to the user at operation 418. The client computing device provides the one or more feedback questions to the user utilizing any known visual, audio, tactile, holographic, and/or other sensory mechanisms. For example, the client computing device may provide the one or more feedback questions through a visual display on a display screen on the client computing device.

In some aspects, feedback method 400 includes operations 420, 422, 424, 426, and/or 428. At operation 420, a reply or response to the one or more feedback questions from the identified user is collected. In some aspects, other responses or replies from other members of the target group along with their other corresponding feedback questions are also collected at operation 420.

The collected quantitative feedback (user engagement and usage context) and the collected qualitative feedback (replies to any provided feedback questions) from the user for the application and/or one or more components of the application may be analyzed at operation 422. In some aspects, the collected quantitative and qualitative feedback from the user for the application and/or one or more components of the application is analyzed along with collected quantitative feedback for other users (other user engagements and other usage contexts) and qualitative feedback for other users (other replies provided in response to other feedback questions) in the target group for the application and/or one or more components of the application at operation 422.

At operation 424, a recommendation is determined for the application and/or one or more components of the application based on the analysis performed at operation 422. The recommendation may include ideas for improving the application and/or one or more components of the application based on the analysis performed at operation 422.

At operation 426, the reply, feedback questions, other replies, other feedback questions, engagement rate, usage context, other user engagement rates, other usage contexts, and/or recommendation(s) may be provided to an administrator of the application. In some aspects, this collected information is provided to the administrator at operation 426 by providing access to the collected information. In other aspects, this information is provided to the administrator at operation 426 by sending the collected information to the administrator.

In further aspects, the service, feature, and/or application are modified based on the recommendation at operation 428. In some aspects, operation 428 is performed in response to the determination of a recommendation. In other aspects, operation 428 is performed in response to collecting an acceptance of the provided recommendation by the administrator.

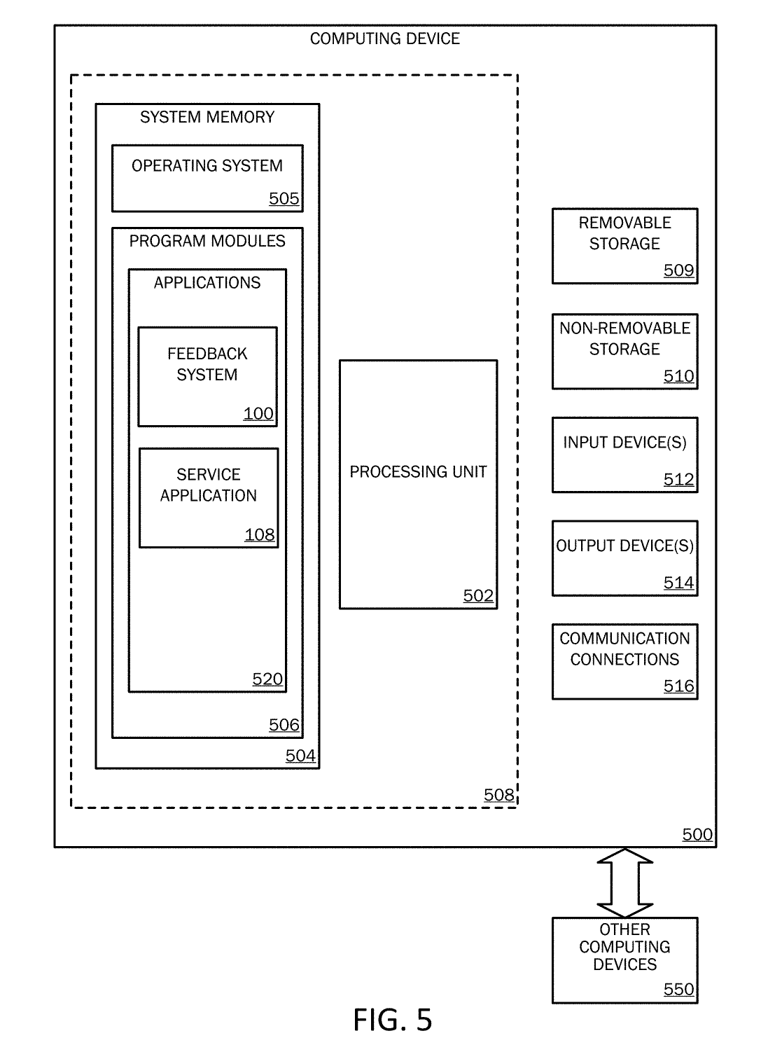

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. For example, the feedback system 100 could be implemented by the computing device 500. In some aspects, the computing device 500 is a mobile telephone, a smart phone, a tablet, a phablet, a smart watch, a wearable computer, a personal computer, a desktop computer, a gaming system, a laptop computer, and/or etc. The computing device components described below may include computer executable instructions for the feedback system 100 and/or the service application 108 that can be executed to employ feedback method 400 as disclosed herein. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combined of such memories. The system memory 504 may include an operating system 505 and one or more program modules 506 suitable for running software applications 520. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., feedback system 100 and/or service application 108) may perform processes including, but not limited to, performing feedback method 400 as described herein. For example, the processing unit 502 may implement the feedback system 100 and/or service application 108. Other program modules that may be used in accordance with aspects of the present disclosure, and in particular to generate screen content, may include a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a device control application, a web interface application, a calendaring application, etc. In some aspects, the service application is one or more of the above referenced applications.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a microphone or other sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

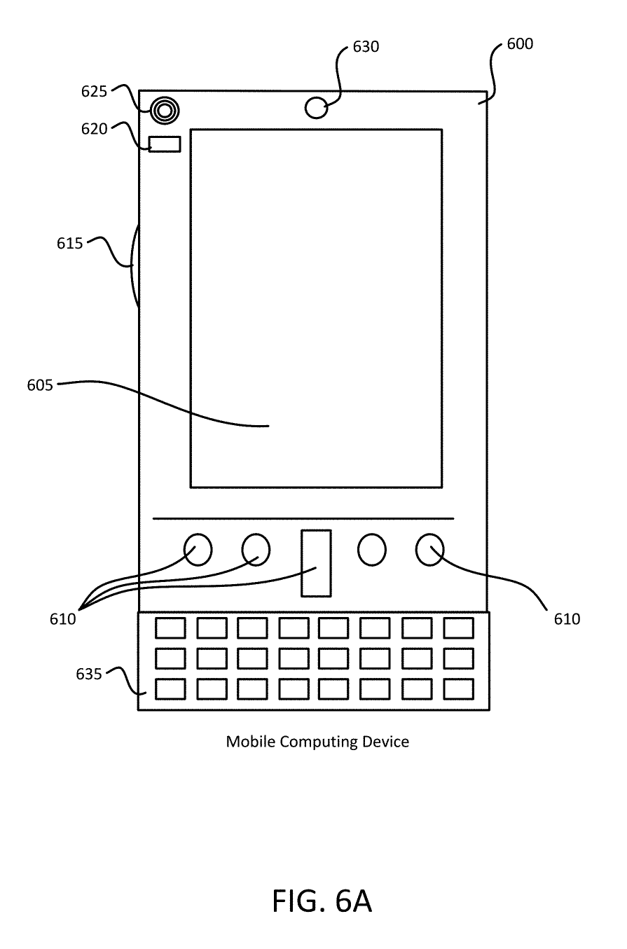

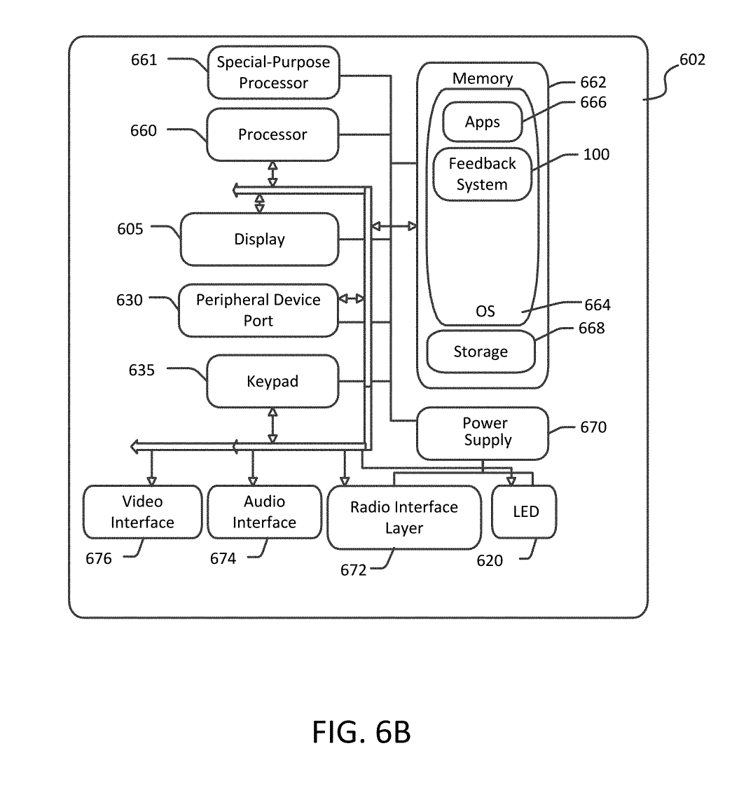

FIGS. 6A and 6B illustrate a mobile computing device 600, for example, a mobile telephone, a smart phone, a tablet, a phablet, a smart watch, a wearable computer, a personal computer, a desktop computer, a gaming system, a laptop computer, or the like, with which aspects of the disclosure may be practiced. With reference to FIG. 6A, one aspect of a mobile computing device 600 suitable for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display.

In addition to, or in place of a touch screen input device associated with the display 605 and/or the keypad 635, a Natural User Interface (NUI) may be incorporated in the mobile computing device 600. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various aspects, the output elements include the display 605 for showing a graphical user interface (GUI). In aspects disclosed herein, the various user information collections could be displayed on the display 605. Further output elements may include a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one aspect, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 and/or the feedback system 100 run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated aspect, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

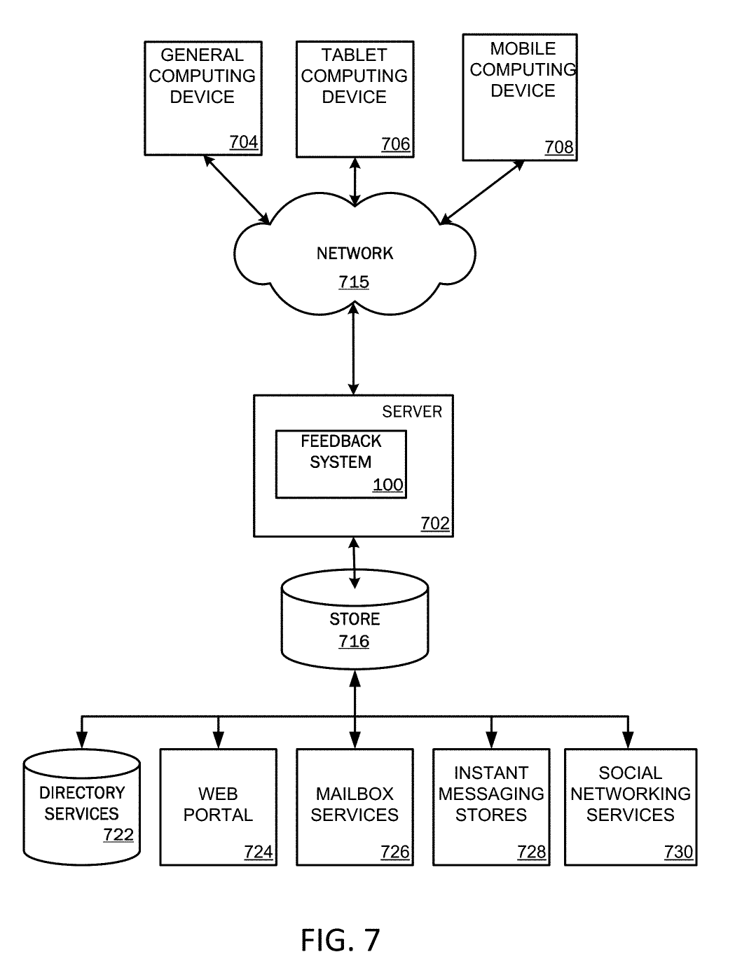

FIG. 7 illustrates one aspect of the architecture of a system for processing data received at a computing system from a remote source, such as a general computing device 704, tablet 706, or mobile device 708, as described above. Content displayed and/or utilized at server device 702 may be stored in different communication channels or other storage types. For example, various documents may be stored using a directory service 722, a web portal 724, a mailbox service 726, an instant messaging store 728, and/or a social networking site 730. By way of example, the feedback system 100 and/or the service application may be implemented in a general computing device 704, a tablet computing device 706 and/or a mobile computing device 708 (e.g., a smart phone). In some aspects, the server 702 is configured to implement a feedback system 100 and/or the service application 108, via the network 715 as illustrated in FIG. 7.

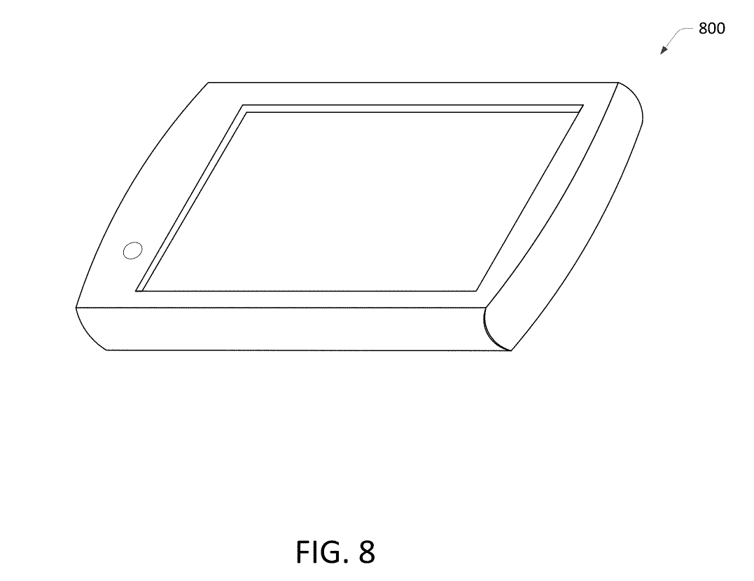

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Embodiments of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific embodiments disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various embodiments disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

1. A targeted feedback system for an online service application, the targeted feedback system comprising:
at least one processor; and
a memory for storing and encoding computer executable instructions that, when executed by the at least one processor is operative to:
identify a user accessing the application;
collect at least one of type data and usage data associated with the user;
compare at least one of the type data and the usage data to a group threshold;
determine that at least one of the type data and the usage data meets the group threshold;
identify that the user is a member of a target group based on the determining that at least one of the type data and the usage data meets the group threshold;
providing a new component of the application to the user in response to identifying that the user is in the target group;
collect user engagement with respect to the new component;
analyze the user engagement to determine a usage context of the user during use of the new component;
generate a feedback question regarding the new component based on the usage context; and
provide the feedback question to the user.

2. The targeted feedback system of claim 1, wherein the at least one processor is further operative to:
collect a reply from the user to the feedback question; and
provide the reply to an administrator of the online service application.

3. The targeted feedback system of claim 1, wherein the at least one processor is further operative to:
collect a reply from the user to the feedback question;
analyze the reply and the usage context;
determine a recommendation for the new component based on the analysis of the reply and the usage context; and
provide the recommendation to an administrator of the online service application.

4. The targeted feedback system of claim 1, wherein the at least one processor is further operative to:
collect a reply from the user to the feedback question;
collect other responses from other users in the target group;
analyze the reply and the other responses;
determine a recommendation for the new component based on the analysis of the reply and the other responses; and
provide the recommendation to an administrator of the online service application.

5. The targeted feedback system of claim 1, wherein the at least one processor is further operative to:
collect a reply from the user to the feedback question;
analyze the reply;
determine a recommendation for the new component based on the analysis of the reply and the usage context; and
modify the new component based on the recommendation.

6. The targeted feedback system of claim 1, wherein the at least one processor is further operative to:
collect a reply from the user to the feedback question;
collect other responses and other corresponding usage contexts for other users in the target group;
analyze the reply, the other responses, and the other corresponding usage contexts to form an analysis;
determine a recommendation for the new component based on the analysis; and
modify the new component based on the recommendation.

7. The targeted feedback system of claim 1, wherein the at least one processor is further operative to:
collect a reply from the user to the feedback question;
collect other responses from other users in the target group;
analyze the reply and the other responses;
determine a recommendation for the new component based on the analysis of the reply and the other responses;
provide the recommendation to an administrator of the online service application;
collect acceptance of the recommendation from the administrator; and
modify the new component based on the acceptance.

8. The targeted feedback system of claim 1, wherein the group threshold is a minimum usage rate of the application.

9. The targeted feedback system of claim 1, wherein the group threshold is a minimum usage rate of an identified service of the application and an identified user demographic.

10. The targeted feedback system of claim 1, wherein the application is a search engine.

11. The targeted feedback system of claim 1, wherein the usage context identifies an aspect of the new component that the user is currently utilizing.

12. The targeted feedback system of claim 1, wherein the usage context identifies any aspects of the new component that the user utilized.

13. The targeted feedback system of claim 1, wherein the usage context identifies any aspects of the new component that the user utilized and how long each aspect was utilized by the user.

14. The targeted feedback system of claim 1, wherein the targeted feedback system is implemented on a network of servers.

15. A targeted feedback method for an online service application, the method comprising:
collecting data associated with a user of the application;
comparing the data to a group threshold;
determining that the data meets the group threshold;
collecting user engagement of the application in response to determining that the data meets the group threshold;
analyzing the user engagement to determine a usage context for the application;
generating a feedback question for the application based on at least one of the usage context and the data; and
providing the feedback question to the user.

16. The method of claim 15, further comprising:
collecting a reply from the user to the feedback question;
analyzing the reply;
determine a recommendation for the application based on the analysis of the reply; and
provide the recommendation to an administrator of the online service application.

17. The method of claim 15, wherein collecting user engagement of the application in response to determining that the data meets the group threshold comprises:
collecting the user engagement of at least one of a new application version, a new application feature, or a new application service.

18. The method of claim 17, further comprising:
providing at least one of the new application version, the new application feature or the new application service to the user in response to determining that the data meets the group threshold.

19. A targeted feedback system for an online application, the system comprising:
a computing device including a processing unit and a memory, the processing unit implementing an application and a feedback system, the computing device is operable to:
identify a user of the application;
compare at least one of type data and usage data associated with the user to a group threshold;
determine if at least one of the type data and the usage data meets the group threshold;
in response to a determination that at least one of the type data and the usage data meets the group threshold:
collect user engagement of at least one identified component of the application;
determine a usage context for the identified component based on the user engagement;
generate a feedback question for the identified component based on the usage context; and
provide the feedback question to the user.

20. The system of claim 19, wherein the computing device is operable to:
in response to a determination that at least one of the type data and the usage data does not meet the group threshold, select not to collect the user engagement with respect to any component provided by the application.
